(19) United States
(12) Patent Application Publication
(10) Pub. No.: US 2013/0126689 A1
(43) Pub. Date: May 23, 2013

(54) APPARATUS, SYSTEM, AND METHOD FOR A DUAL-ARMED HUNTING DISPLAY

(71) Applicant: Nathan Brett Richards, Huntington, UT (US)

(72) Inventor: Nathan Brett Richards, Huntington, UT (US)

(21) Appl. No.: 13/301,478

(22) Filed: Nov. 21, 2011

(51) Int. Cl. A47F 7/00; B23P 11/00; F16M 13/00

(52) U.S. Cl. 248/288.31; 248/288.11; 29/428

(57) ABSTRACT

The apparatus for a dual-armed hunting display includes a base plate and a first arm and a second arm movably coupled to the base plate. The first arm and the second arm are each movable around at least two axes. The first arm is spaced apart from the second arm. The embodiment of the apparatus also includes a first holding member coupled to a distal end of the first arm and a second holding member coupled to a distal end of the second arm.

### FIELD

The present disclosure relates to hunting displays and more particularly relates to a dual-armed hunting display.

### BACKGROUND

Male moose, elk and deer typically shed their antlers in the late winter or early spring. These discarded antlers are often referred to as “shed antlers.” Shed antlers are often highly sought after by hunters, collectors, and decorators for trophy displays, decoration, and even furniture.

Typically, a shed antler is more valuable in its original form, not damaged or modified—such as by drilling or altering the antler for mounting. In addition, because shed antlers are not attached to the head or skull of the animal, a pair of shed antlers lack a common mounting point to display the shed antlers as they appeared on the animal.

### SUMMARY

From the foregoing discussion, it should be apparent that a need exists for an apparatus, system, and method for a dual-armed hunting display. Beneficially, such an apparatus, system, and method would include dual, independently movable arms.

The present disclosure has been developed in response to the present state of the art, and in particular, in response to the problems and needs in the art that have not yet been fully solved by currently available hunting displays. Accordingly, the present subject matter has been developed to provide an apparatus, system, and method for a dual-armed hunting display that overcome many or all of the above-discussed shortcomings in the art.

One embodiment of an apparatus for a dual-armed hunting display includes a base plate and a first arm and a second arm movably coupled to the base plate. The first arm and the second arm are each movable around at least two axes. The first arm is spaced apart from the second arm. The embodiment of the apparatus also includes a first holding member coupled to a distal end of the first arm and a second holding member coupled to a distal end of the second arm.

In certain implementations of the apparatus, the first arm and the second arm are each movable around three axes. In some implementations, the first arm and the second arm are each independently movable.

In some implementations, the apparatus includes a first coupling mechanism movably coupling the first arm to the base plate and a second coupling mechanism movably coupling the second arm to the base plate. The first coupling mechanism and the second coupling mechanism may each include a first coupling movable retained by a second coupling. The first coupling of the first arm and the first coupling of the second arm may be coupled to the first arm and the second arm respectively. The second coupling of the first arm and the second coupling of the second arm may each be coupled to the base plate. The first coupling of the first arm may be located on an end of the first arm opposite the distal end of the first arm and the first coupling of the second arm may be located on an end of the second arm opposite the distal end of the second arm. The first coupling may be a ball and the second coupling may be a socket that movably retains the ball. Furthermore, each of the first coupling mechanism and the second coupling mechanism may include a position fixing mechanism that fixes a position of the first arm and the second arm respectively.

In certain implementations, the first arm is coupled to a first side of the base plate and the second arm is coupled to a second side of the base plate opposite the first side. The first arm and the first side of the base plate may mirror the second arm and the second side of the base plate.

In some implementations, the first holding member and the second holding member are each an adjustable prong clamp or an adjustable utility clamp. In certain implementations, the base plate further includes at least one slot and the first arm and the second arm are slidably movable to adjust a distance between the first arm and the second arm. In some implementations, the first arm and the second arm are each independently adjustable to adjust a length of the first arm and a length of the second arm respectively.

An embodiment of an antler display includes a base plate and a first arm and a second arm movably coupled to the base plate. The first arm and the second arm are each independently movable around three axes and the first arm is spaced apart from the second arm. The antler display also includes a first holding member coupled to a distal end of the first arm and a second holding member coupled to a distal end of the second arm. The antler display also includes a first coupling mechanism movably coupling the first arm to the base plate and a second coupling mechanism movably coupling the second arm to the base plate.

In some implementations of the antler holder, the first coupling mechanism and the second coupling mechanism each include a first coupling movable retained by a second coupling. The first coupling of the first arm and the first coupling of the second arm are coupled to the first arm and the second arm respectively and the second coupling of the first arm and the second coupling of the second arm are each coupled to the base plate.

In certain implementations, the first coupling of the first arm is located on an end of the first arm opposite the distal end of the first arm and the first coupling of the second arm is located on an end of the second arm opposite the distal end of the second arm.

In some implementations, the first arm is coupled to a first side of the base plate and the second arm is coupled to a second side of the base plate opposite the first side. The first arm and the first side of the base plate may mirror the second arm and the second side of the base plate.

One embodiment of a method is also presented. The method includes securing a first antler in a first holding member coupled to a distal end of a first arm. The first arm is movably coupled to a base plate. The method includes securing a second antler in a second holding member coupled to a distal end of a second arm. The second arm is movably coupled to the base plate. The first arm and the second arm are each movable around at least two axes. The first arm is spaced apart from the second arm. The method includes independently moving the first arm to adjust a position of the first antler and independently moving the second arm to adjust a position of the second antler.

In certain implementations, a first coupling mechanism movably couples the first arm to the base plate and a second coupling mechanism movably couples the second arm to the base plate. The first coupling mechanism includes a first position fixing mechanism and the second coupling mechanism includes a second position fixing mechanism. The method includes adjusting the first position fixing mechanism to fix a position of the first arm and adjusting the second position fixing mechanism to fix a position of the second arm.

Reference throughout this specification to features, advantages, or similar language does not imply that all of the features and advantages that may be realized with the present subject matter should be or are in any single embodiment of the subject matter. Rather, language referring to the features and advantages is understood to mean that a specific feature, advantage, or characteristic described in connection with an embodiment is included in at least one embodiment of the present subject matter. Thus, discussion of the features and advantages, and similar language, throughout this specification may, but do not necessarily, refer to the same embodiment.

Furthermore, the described features, advantages, and characteristics of the subject matter may be combined in any suitable manner in one or more embodiments. One skilled in the relevant art will recognize that embodiments of the subject matter may be practiced without one or more of the specific features or advantages of a particular embodiment. In other instances, additional features and advantages may be recognized in certain embodiments that may not be present in all embodiments of the subject matter.

These features and advantages of the present subject matter will become more fully apparent from the following description and appended claims, or may be learned by the practice of the subject matter as set forth hereinafter.

### BRIEF DESCRIPTION OF THE DRAWINGS

In order that the advantages of the present subject matter will be readily understood, a more particular description of the present subject matter briefly described above will be rendered by reference to specific embodiments that are illustrated in the appended drawings. Understanding that these drawings depict only typical embodiments of the subject matter and are not therefore to be considered to be limiting of its scope, the present subject matter will be described and explained with additional specificity and detail through the use of the accompanying drawings, in which:

FIG. 1 is a frontal perspective view illustrating one embodiment of an apparatus for a dual-armed hunting display in accordance with the present subject matter;

FIG. 2A is a frontal perspective view illustrating one embodiment of a base plate in accordance with the present subject matter;

FIG. 2B is a top view further illustrating the base plate of FIG. 2A in accordance with the present subject matter;

FIG. 2C is another frontal perspective view further illustrating the base plate of FIG. 2A in accordance with the present subject matter;

FIG. 3A is a frontal view illustrating another embodiment of a base plate in accordance with the present subject matter;

FIG. 3B is a top view further illustrating the base plate of FIG. 3A in accordance with the present subject matter;

FIG. 3C is a frontal view illustrating yet another embodiment of a base plate in accordance with the present subject matter;

FIG. 3D is a frontal view illustrating an additional embodiment of a base plate in accordance with the present subject matter;

FIG. 4A is a partial cross-sectional side view illustrating one embodiment of a coupling mechanism coupled to a base plate in accordance with the present subject matter;

FIG. 4B is a partial cross-sectional side view illustrating another embodiment of a coupling mechanism coupled to a base plate in accordance with the present subject matter;

FIG. 5A is a perspective view illustrating one embodiment of a coupling mechanism movable around three axes in accordance with the present subject matter;

FIG. 5B is a perspective view illustrating one embodiment of a coupling mechanism movable around two axes in accordance with the present subject matter;

FIG. 6A is a frontal perspective view illustrating one embodiment of an arm and holding member in accordance with the present subject matter;

FIG. 6B is a side perspective view illustrating the arm and holding member of FIG. 6A in accordance with the present subject matter;

FIG. 6C is a side perspective view illustrating another embodiment of an arm and holding member in accordance with the present subject matter;

FIG. 7A is a perspective view illustrating one embodiment of a holding member releasable engaged with a shed antler in accordance with the present subject matter;

FIG. 7B is a perspective view illustrating another embodiment of a holding member releasable engaged with a shed antler in accordance with the present subject matter;

FIG. 7C is a perspective view illustrating one embodiment of a dual-armed hunting display apparatus releasably engaged with a first antler and a second antler in accordance with the present subject matter;

FIG. 8 is a frontal perspective view illustrating one embodiment of a dual-armed hunting display apparatus in a folded position in accordance with the present subject matter;

FIG. 9 is a frontal perspective view illustrating one embodiment of a dual-armed hunting display apparatus releasably engaged with a recurve bow in accordance with the present subject matter; and

FIG. 10 is a schematic block diagram illustrating one embodiment of a method in accordance with the present subject matter.

### DETAILED DESCRIPTION

Reference throughout this specification to “one embodiment,” “an embodiment,” or similar language means that a particular feature, structure, or characteristic described in connection with the embodiment is included in at least one embodiment of the present subject matter. Thus, appearances of the phrases “in one embodiment,” “in an embodiment,” and similar language throughout this specification may, but do not necessarily, all refer to the same embodiment.

Furthermore, the described features, structures, or characteristics of the subject matter may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the subject matter. One skilled in the relevant art will recognize, however, that embodiments of the present subject matter may be practiced without one or more of the specific details, or with other methods, components, materials, and so forth. In other instances, well-known structures, materials, or operations are not shown or described in detail to avoid obscuring aspects of the present subject matter.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

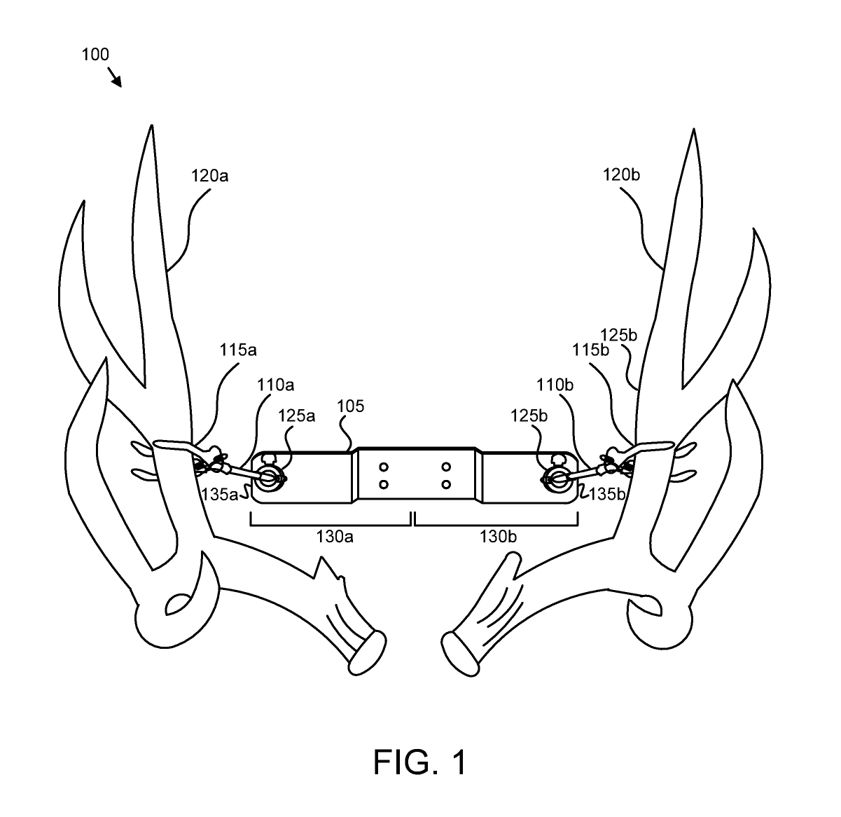

FIG. 1 depicts a frontal perspective view of one embodiment of an apparatus for a dual-armed hunting display 100. In one embodiment, the apparatus comprises an antler display. The apparatus 100, as depicted, includes a base plate 105 and a first arm 110a and a second arm 110b movably coupled to the base plate 105. The first arm 110a is spaced apart from the second arm 110b. Furthermore, the apparatus 100 includes a first holding member 115a coupled to a distal end of the first arm 110a and a second holding member 115b coupled to a distal end of the second arm 110b.

In the depicted embodiment, the apparatus 100 releasably engages a first antler 120a and a second antler 120b. In one embodiment, each of the first and second antler 120a,b are shed antlers, or antlers from a male moose, elk, deer, or the like, that have been shed by the animal. Of course, in other embodiments, the first and second holding members 115a,b may releasably engage other antlers, horns, and/or other suitable objects. In one embodiment, the first and second antlers 120a,b are freestanding and are not connected together and/or are not connected to a common object such as a skull, head, or mounting device.

Because the first and second antlers 120a,b are freestanding, an antler owner may have difficulty arranging the antlers 120a,b for display without damaging or modifying the antlers 120a,b (e.g. drilling a hole through the antlers 120a,b). Therefore, the first and second holding members 115a,b of the apparatus 100, in the depicted embodiment, may releasably engage the first antler 120a and the second antler 120b respectively. The first and second holding members 115a,b may engage each antler 120a,b without damaging or otherwise modifying the antlers 120a,b, thus preserving their value and natural condition.

In certain embodiments, the first arm 110a and the second arm 110b are each movable around at least two axes. In one embodiment, the first arm 110a and the second arm 110b are each independently movable and allow for independent positioning of each antler 120a,b.

In the depicted embodiment, the apparatus 120 includes a first coupling mechanism 125a movably coupling the first arm 110a to the base plate 105 and a second coupling mechanism 125b movably coupling the second arm 110b to the base plate 105. In certain embodiments, the first and second coupling mechanisms 125a,b allow the first arm 110a and the second arm 110b to move around at least two axes. In certain embodiments, the first and second coupling mechanisms 125a,b allow for movement around three axes as described below.

In the depicted embodiment, the first arm 110a is coupled to a first side 130a of the base plate 105 and the second arm 110b is coupled to a second side 130b of the base plate 105 opposite the first side. In addition, the first arm 110a and the first side 130a of the base plate 105 mirror the second arm 110b and the second side 130b of the base plate 105.

Although two arms 110a,b, two coupling mechanisms 125a,b, and two holding members 115a,b are depicted in FIG. 1, in certain embodiments, the apparatus 100 includes a single arm 110a movably coupled to the base plate 105. The single arm 110a may be movably coupled with a single coupling mechanism 125a and may include a holding member 115a as described herein in relation to the first and second arms 110a,b. For example, an antler owner may wish to display a single shed antler in a single arm 110a embodiment of the apparatus 100.

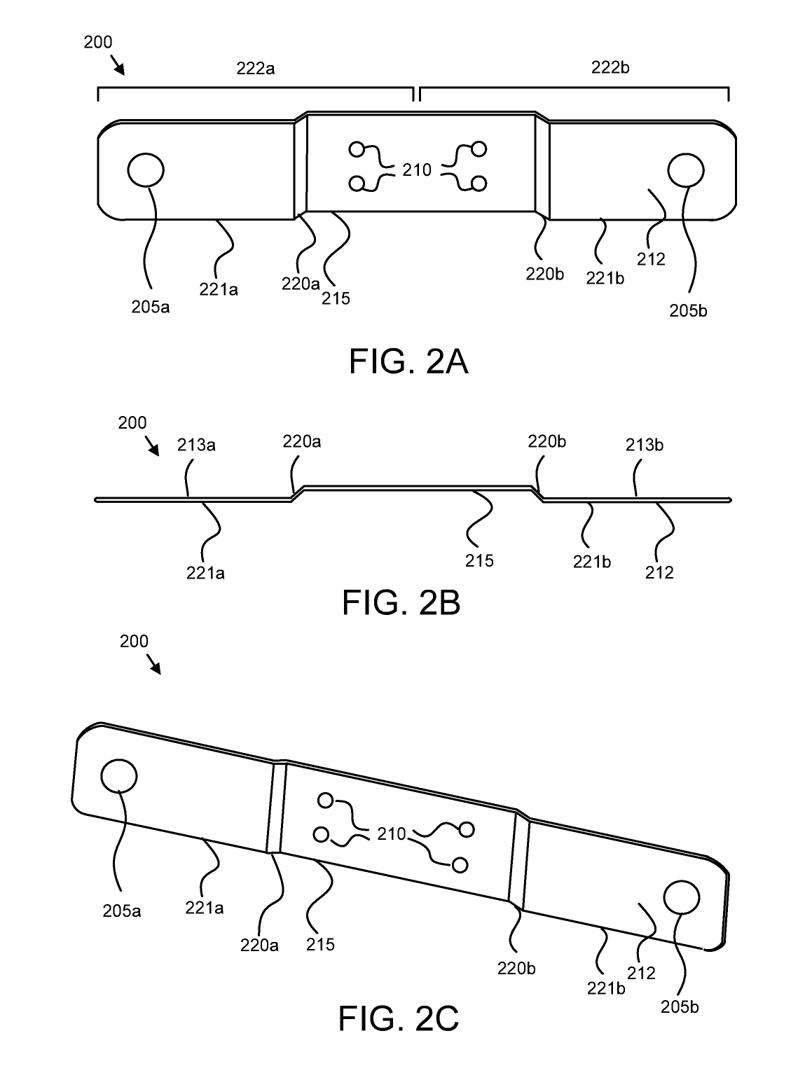

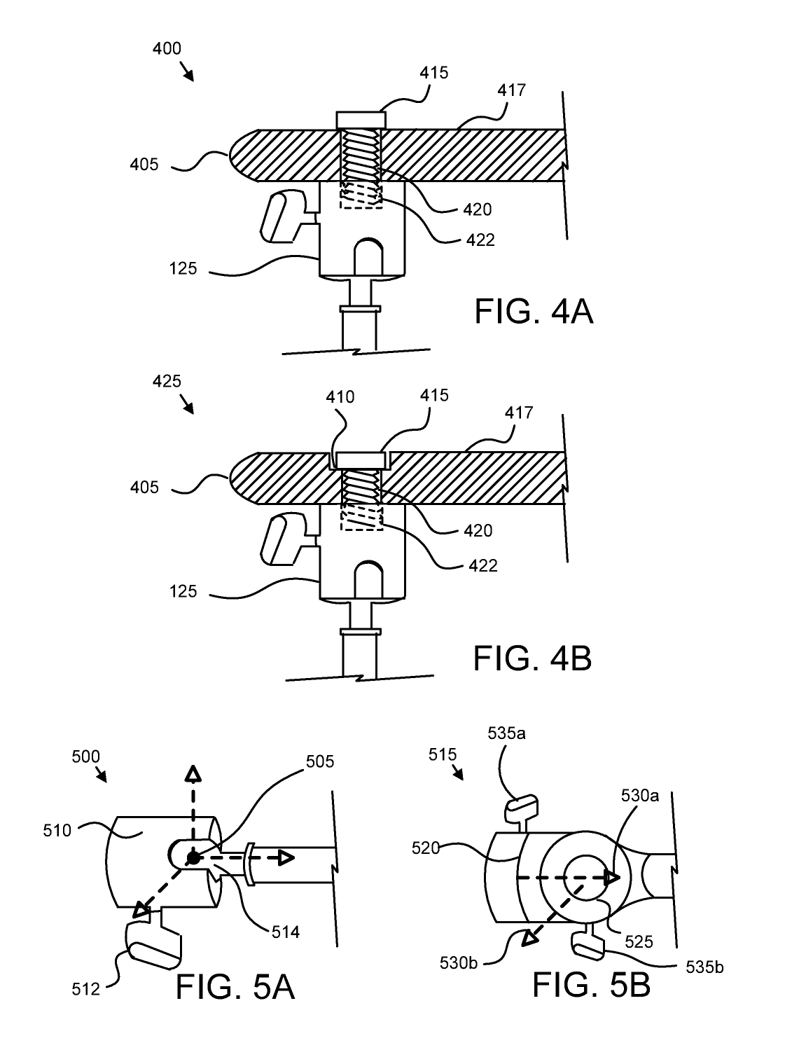

FIGS. 2A and 2B depict frontal perspective views of one embodiment of a base plate 200. The base plate 200 may comprise one embodiment of the base plate 105 of FIG. 1. The base plate 200 includes a first mount aperture 205a and a second mount aperture 205b to couple the first coupling mechanism 125a and the second coupling mechanism 125b respectively to the base plate 200. In the depicted embodiment, each of the first mount aperture 205a and the second mount aperture 205b comprise an aperture through the base plate 200. Referring to FIGS. 4A and 4B, in one embodiment, a particular coupling mechanism 125 (e.g. the first or the second coupling mechanism 125a,b) comprises a hole 422 with threads (e.g. certain ball and socket joints comprise a threaded hole on an end). The particular coupling mechanism 125 may be coupled to the base plate 405 with a bolt or screw 420 extending through the particular mount aperture (e.g. the first or the second mount aperture 205a,b) from a back surface 417 of the base plate 405 and into the hole 422 in the particular coupling mechanism 125 where the screw engages opposing threads in the hole 422.

Referring back to FIGS. 2A and 2C, in other embodiments, the first and second coupling mechanisms 125a,b are welded, glued, or otherwise directly attached to a face 212 of the base plate 200 and the base plate 200 does not include mount apertures 205a,b as depicted. In the depicted embodiment, the base plate 200 also includes a plurality of surface mount points 210 suitable to secure the base plate 200 to a wall or other surface. Each surface mount point 210 in the depicted embodiment comprises an aperture through the base plate 200 suitable to secure the base plate 200 to a surface using nails, screws, or the like. Of course, the base plate 200 may be attached to a surface using any suitable mechanism. In addition, although the depicted base plate 200 includes four surface mount points 210, the base plate 200 may include any suitable number of surface mount points 210.

In the depicted embodiment, the base plate 200 defines a recess 215. Specifically, the base plate 200 includes a first angled section 220a and a second angled section 220b that, referring also to FIG. 2B, define a recess 215 suitable to maintain a distance between a surface in which the base plate 200 is attached (an attachment surface) and a back surface 213a of a first end 221a of the base plate 200 and a back surface 213b of a second end 221b of the base plate 200. Referring also to FIG. 4A, in certain embodiments, a coupling mechanism 125 may be coupled to the base plate 200,405 with bolts or screws 420 extending through a mount aperture 205 from a back surface 417 of the base plate 200,405 and into a coupling mechanism 125 as described above. The recess 215 maintains a distance between the attachment surface and the first and second ends 221a,b of the base plate 200,405 to accommodate the bolt/screw heads 415 extending from the back surface 417 of the first and second ends 221a,b of the base plate 200,405. FIG. 2B is a top view of the base plate 200 of FIG. 2A and also depicts the first and second ends 221a,b of the base plate 200, the first and second angled sections 220a,b, and the recess 215.

Referring back to FIGS. 2A and 2C, in the depicted embodiment, a first side 222a of the base plate 200 mirrors a second side 222b of the base plate 200. Furthermore, the base plate 200 may rigid and stable and may be made of metal such as steel, aluminum, or the like. In other embodiments, the base plate 200 is plastic, resin, or another suitable material. In an example embodiment, the base plate 200 is approximately 2-3 inches by 12-18 inches and approximately ⅛-⅜ inches thick.

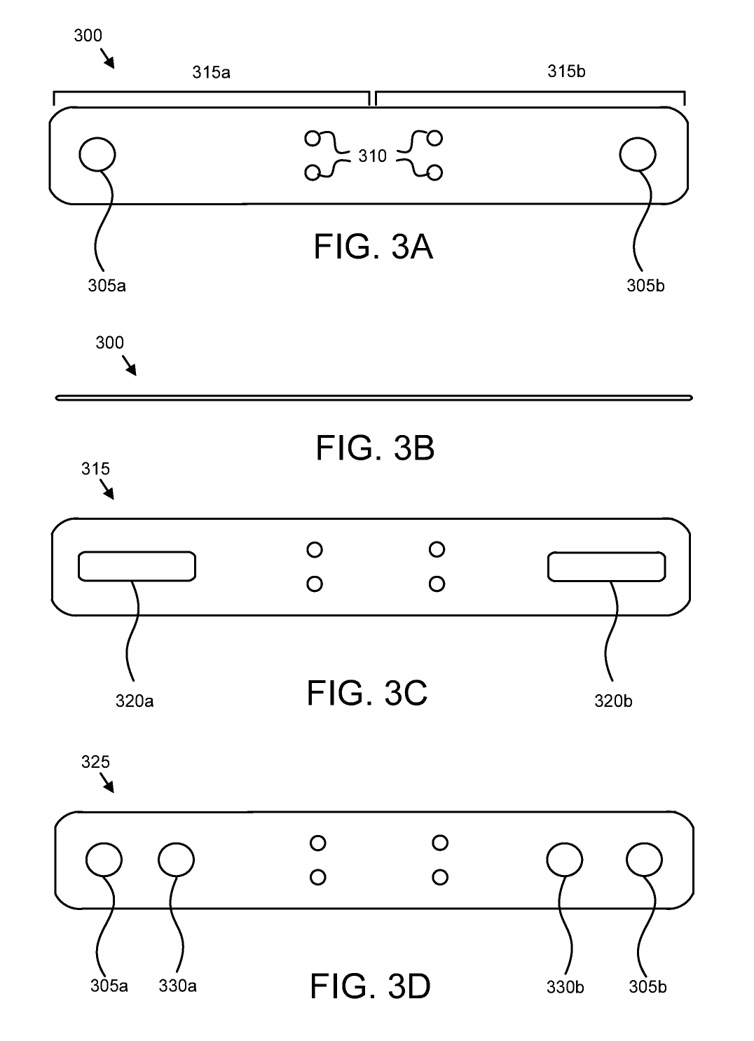

FIG. 3A is a frontal view depicting another embodiment of a base plate 300. Like the base plate 200 depicted in FIG. 2, the base plate 300 may comprise one embodiment of the base plate 105 in FIG. 1. Referring also to FIG. 3B, a top view of the base plate 300, the base plate 300 is substantially planar. The base plate 300, like the base plate 200 in FIG. 2A, includes a first mount aperture 305a and a second mount aperture 305b to couple the first coupling mechanism 125a and the second coupling mechanism 125b respectively to the base plate 300. In the depicted embodiment, each of the first mount aperture 305a and the second mount aperture 305b comprise an aperture through the base plate 300. Referring also to FIGS. 4A and 4B, as described above, the coupling mechanisms 125a,b may be coupled to the base plate 300,405 with bolts or screws 420 extending through the first and second mount aperture 305a,b from a back surface 417 of the base plate 300,405 and into threaded holes 422 the first and second coupling mechanisms 125a,b respectively as described above. Referring specifically to FIG. 4B, in one embodiment, the base plate 405 includes an indentation 410 to accommodate the head 415 of the bolt/screw such that the base plate 405 may rest flush against the attachment surface (e.g. the wall). Referring back to FIGS. 3A and 3B, in other embodiments, the first and second coupling mechanisms 125a,b are welded, glued, or otherwise directly attached to a face of the base plate 300 and the base plate 300 does not include mount apertures 305a,b as depicted.

Like the base plate 200 in FIG. 2A, the base plate 300 also includes a plurality of surface mount points 310 suitable to secure the base plate 300 to a wall or other surface. Each surface mount point 310 in the depicted embodiment comprises an aperture through the base plate 300 suitable to secure the base plate 300 to a surface using nails, screws, or the like.

Like the base plate 200 of FIG. 2A, a first side 315a of the depicted base plate 300 mirrors a second side 315b of the base plate 300. Furthermore, the base plate 300 may be rigid and stable and may be made of metal such as steel, aluminum, or the like. In other embodiments, the base plate 300 is plastic, resin, or another suitable material. In an example embodiment, the base plate 300 is approximately 2-3 inches by 12-18 inches and approximately ⅛-⅜ inches thick.

A base plate 105 may include at least one slot to couple the coupling mechanisms. FIG. 3C is a frontal view depicting another embodiment of a base plate 315 similar to the base plate 315 of FIGS. 3A and 3B except that the base plate 315 includes a first slot 320a and a second slot 320b. The first slot 320a and the second slot 320b allow the first arm 110a and the second arm 110b to be slidably movable to adjust a distance between the first arm 110a and the second arm 110b. The first arm 110a and the second arm 110b may be movably coupled to the base plate 315 using first and second coupling mechanisms 125a,b through the first and second slots 320a,b respectively. For example, a particular coupling mechanism 125a may be coupled to the base plate 315 with bolts or screws extending through a particular slot 320a (e.g. the first slot 320a or the second slot 320b) from a back surface of the base plate 315 and into the particular coupling mechanism 125a at a particular location in the particular slot 320a. In one embodiment, a user may loosen a bolt holding the particular coupling mechanism 125a and slidably move the particular coupling mechanism 125a to a desired location and tighten a bolt/screw to fix the coupling mechanism 125a in place at the desired location. In other embodiments, the base plate 315 includes a single slot extending across the base plate 315.

FIG. 3D is a frontal view depicting yet another embodiment of a base plate 325. The base plate 325 may be similar to the base plate 300 in FIG. 3A except that the base plate 325 includes four mount apertures 305a,b 330a,b—two mount apertures on each side of the base plate 325—allowing an arm to be movably coupled to the base plate 325 on each side of the base plate 325 in a first mount aperture 305a,b or a second mount aperture 330a,b.

FIG. 5A is a perspective view depicting one embodiment of a coupling mechanism 500 that is movable around three axes 505. The coupling mechanism 500 may comprise one embodiment of the coupling mechanism 125a,b depicted in FIG. 1. In the depicted embodiment, the coupling mechanism 500 includes a first coupling 514 movable retained by a second coupling 510. In the depicted embodiment, the first coupling 514 is a ball and the second coupling is a socket 510 that movably retains the ball 514. The depicted coupling mechanism 500 allows an arm 110 coupled to the first coupling 514 to rotational move about three axes 505 from a single point. An antler may be moved in any number of positions because of the movement allowed by the coupling mechanism 500.

In the depicted embodiment, the coupling mechanism 500 includes a position fixing mechanism 512 configured to fix a position of the first coupling 514 (e.g. the ball). In one embodiment, the position fixing mechanism 512 includes a screw on the second coupling 510 that, when tightened, increases tension and/or pressure on the first coupling 514 to fix a position of the first coupling 514 in the second coupling 510. The coupling mechanism 500 may be metal such as steel or aluminum, plastic, resin, or other suitable material. In one embodiment, the coupling mechanism 500 comprises a ball and socket joint from Giottos Industrial Inc with a position fixing mechanism 512.

FIG. 5B is a perspective view depicting one embodiment of a coupling mechanism 515 that is movable around two axes 530a,b. The coupling mechanism 515 may comprise one embodiment of the coupling mechanism 125a,b depicted in FIG. 1. In the depicted embodiment, the coupling mechanism 515 includes a first joint 520 movable around a first axis 530a and a second joint 525 movable around a second axis 530b. The depicted embodiment includes a first position fixing mechanism 535a to fix a position on the first axis 530a and a second position fixing mechanism 535b to fix a position on the second axis 530b. The first and second position fixing mechanisms 535a,b may be embodied as screws that, when tightened, increase tension in the first and second joints 525 respectively. The coupling mechanism 515 may be metal such as steel or aluminum, plastic, resin, or other suitable material.

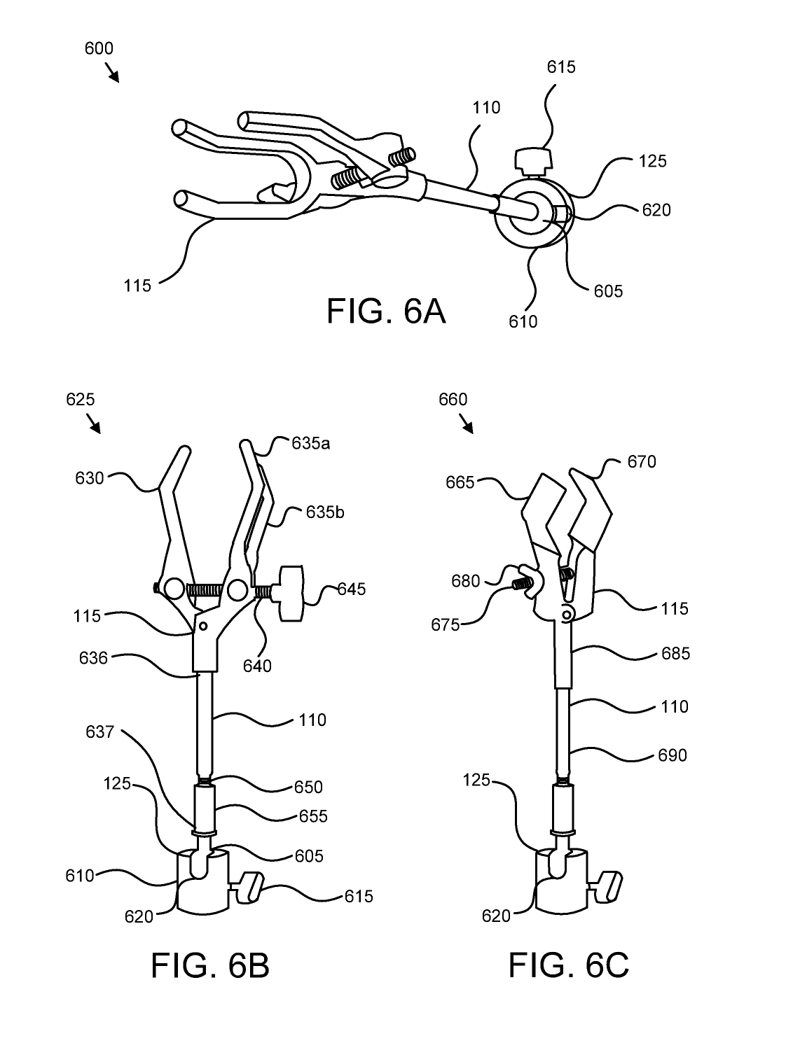

FIG. 6A is a frontal perspective view depicting one embodiment of an arm 110 and holding member 115. In FIGS. 6A and 6B, the arm 110, holding member 115, and coupling mechanism 125 may be substantially similar to like numbered elements in FIG. 1, representing one or more of the first or second arm 110a,b, the first or second holding member 115a,b, and the first or second coupling mechanism 125a,b. Referring also to FIG. 6B, in the depicted embodiment, the arm 110 and holding member 115 are movably coupled to a coupling mechanism 125.

As described above, the coupling mechanism 125 may include a first coupling 605 movable retained by a second coupling 610. In the depicted embodiment, the first coupling 605 (e.g. a ball) is coupled to the arm 110 and the second coupling 610 (e.g. a socket) is coupled to the base plate 105 as described above. In the depicted embodiment, the coupling mechanism 125 includes a position fixing mechanism 615 configured to fix a position of the arm 110. In one embodiment, the position fixing mechanism 615 includes a screw on the second coupling 610 that, when tightened, increases tension on the first coupling 605 to fix a position of the first coupling 605, retaining the arm and holding member 115 in a set position. Although a single position fixing mechanism 615 is depicted, in other embodiments, the coupling mechanism 125 may include multiple position fixing mechanisms 615 (e.g. a position fixing mechanism 615 for each axis of rotation as depicted in FIG. 5B).

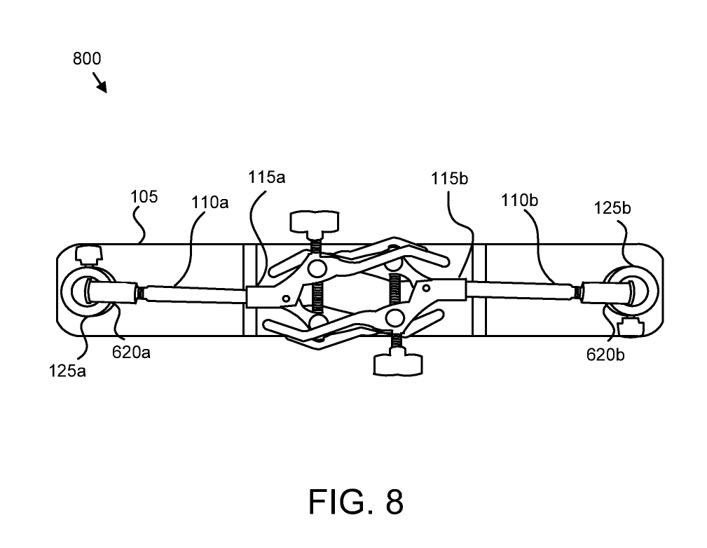

In the depicted embodiment, the coupling mechanism 125, on the second coupling 610, includes a notch 620. The notch 620 is configured to accept a portion of the arm 110 when the arm 110 is positioned toward the notch 620, thus allowing greater movement of the arm 110 when the arm 110 is aligned with the notch 620. Referring to FIG. 8, each of the first and second arms 110a,b may be moved into first and second notches 620a,b, respectively, to fold the hunting display apparatus 100 into a low profile position as depicted. In the depicted embodiment 800, the first and second holding members 115a,b are interlockable to further fold and lower a profile of the hunting display apparatus 100.

Referring back to 6A and 6B, in the depicted embodiment, the arm 110, when movably coupled to the base plate 105, is positionable to extend out from the base plate 105. The arm 110, in one embodiment, is substantially cylindrical. A holding member 115 is coupled to a distal end 636 of the arm 110 and the first coupling of the first arm 110a is located on an end 637 of the first arm 110a opposite the distal end 636 of the first arm 110a. The holding member 115 may be screwed onto the arm 110, welded onto the arm 110, snapped onto the arm 110, or attached with another suitable attachment. Similarly, the arm 110 may be screwed onto the first coupling 605 directly or with a nut 655 (as depicted), welded onto the first coupling 605, or with another suitable attachment. For example, in one embodiment, the first coupling 605 (e.g. the ball) includes threads and the arm 110 includes threads 650, and the arm 110 is coupled to the first coupling 605 using a nut 655 that engages the threads of the arm 110 and the threads of the first coupling 650.

In another embodiment, the arm 110 and the first coupling 605 comprise a continuous molded piece. In one embodiment, at least a portion of the holding member 115 and the arm 110 comprise a continuous molded piece. The holding member 115 and the arm 110 may be made of metal, plastic, resin, or other firm and resilient material. In an example embodiment, the arm 110 measures between 1-4 inches in length and ¼-¾ inch in diameter.

The holding member 115 is configured to grasp, grip, clamp, and/or removably engage an object such as an antler. In the depicted embodiment 600,625, the holding member 115 is an adjustable prong clamp with a first prong 635a and a second prong 635b opposite an opposing prong 630. The adjustable prong clamp 115 includes an adjustment mechanism 645 operable to increase and decrease a distance between the first and second prong 635a,b and the opposing prong 630, suitable to tighten and loosen a grip of the holding member 115 on the object such as the antler. The adjustment mechanism 645, as depicted, may be embodied as a screw 640 threaded through a first side of the clamp (e.g. supporting the first and second prongs 635a,b) and a second side of the clamp with the opposing prong 630. In an example embodiment, the arm 110 combined with the holding member 115 measures between 5-7 inches in length. In an example embodiment, the holding member 115 alone measures between 3-5 inches in length.

FIG. 6C is a side perspective view depicting another embodiment 660 of an arm 110 and holding member 115 that may comprise one or more of the first and second arms 110a,b and the first and second holding members 115a,b of FIG. 1. Specifically, the holding member 115 comprises a utility clamp. The utility clamp 115 includes a first clamping member 665 and a second clamping member 670 and the utility clamp 115 includes an adjustment mechanism 675,680 operable to increase or decrease a distance between the first clamping member 665 and the second clamping member 670 to tighten or loosen the utility clamp 115. The adjustment mechanism 675,680 in the depicted embodiment is embodied as a screw 675 with a nut 680 to hold the first and second clamping members 665, 670 into particular positions. In one embodiment, the first arm 110a and the second arm 110b are each independently adjustable to adjust a length of the first arm 110a and a length of the second arm 110b respectively. As depicted in FIG. 6C, in this embodiment, the arm 110 may include a first hollow section 685 and a second section 690 that is slidably adjustable inside the first hollow section 685 to adjust a length of the arm 110.

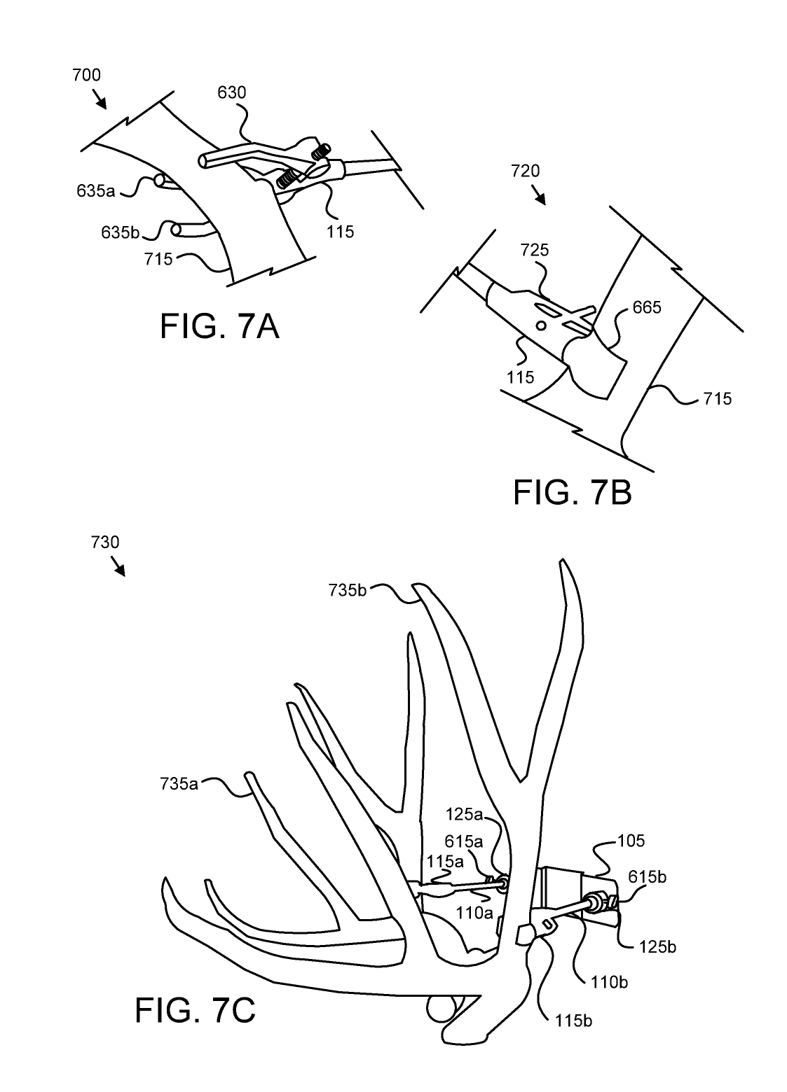

FIG. 7A depicts one embodiment 700 of a holding member 115 according to the present subject matter (e.g. an adjustable prong claim) releasable engaged with an antler 715. The first and second prongs 635a,b of the holding member 115 are in contact with a first side of the antler 715 and the opposing prong 630 is in contact with a second side of the antler 715 opposite the first side. The holding member 115 may be tightened to exert pressure on the antler 715 sufficient to engage the antler 715 without damaging the antler 715. Likewise, FIG. 7B depicts another embodiment 720 of a holding member 115 according to the present subject matter (e.g. an adjustable utility claim) releasable engaged with an antler 715. The holding member 115 may be tightened, by way of the adjustment mechanism 675,680, described above, to exert pressure on the antler 715 sufficient to engage the antler 715 without damaging the antler 715.

FIG. 7C depicts another embodiment of a dual-armed hunting display 730 according to the present subject matter. The first and second holding members 115a,b releasably engage a first antler 735a and a second antler 735b without damaging or modifying the first and second antlers 735a,b. In one embodiment, the first and second antlers 735a,b are shed antlers and are not interconnected or connected to a common anchor. Each of the first and second antlers 735a,b may be independently movable to allow an antler owner to space the antlers 735a,b apart. In one embodiment, each coupling mechanism 125a,b allows movement around at least two axes, allowing an antler owner to position each antler 735a,b to a desired position. In one embodiment, as described above, each coupling mechanism 125a,b allows rotational movement around three axes from a single point, allowing the antler owner to position and rotate each antler 735a,b.

An antler owner may arrange each antler to display the antlers 735a,b as they would have appeared on the animal, spaced apart and positioned to approximate the position and measurements of how the antlers 735a,b appeared on the animal's head. The antler owner may also fix a position of each antler 735a,b with the position fixing mechanism 615a,b on each coupling mechanism 125 respectively, securing each antler 735a,b at a particular angle and at a particular distance from the other antler 735a,b.

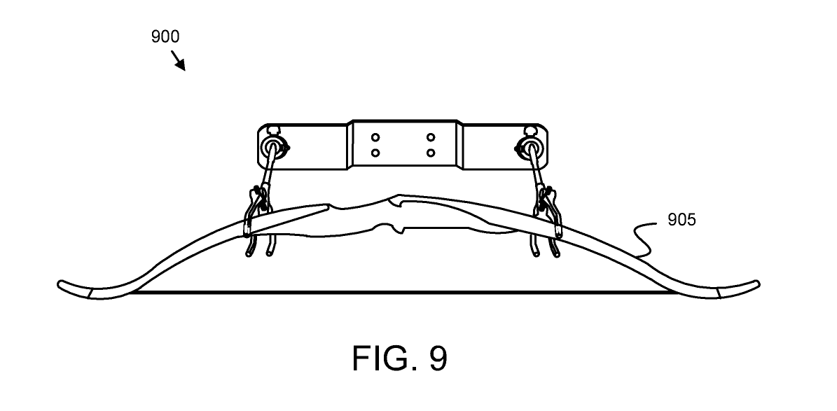

In one embodiment, the dual-armed hunting display apparatus 900 may also hold, engage, and/or display other objects. FIG. 9 depicts one embodiment of a dual-armed hunting display apparatus releasably engaged with a recurve bow 905.

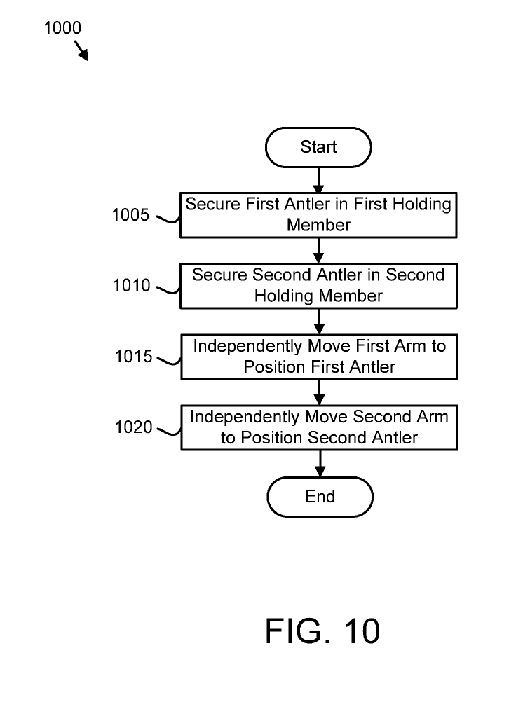

FIG. 10 is a schematic block diagram illustrating one embodiment of a method 1000. The method 1000 may be implemented by an operator, a user, an antler owner, and/or the like. The method 1000 begins and includes securing 1005 a first antler 120a in a first holding member 115a coupled to a distal end of a first arm 110a that is movably coupled to a base plate 105. Next, the method 1000 includes securing 1010 a second antler 120b in a second holding member 115b coupled to a distal end of a second arm 110b that is movably coupled to the base plate 105. The first and second arm 110a,b are each movable around at least two axes and the first arm 110a is spaced apart from the second arm 110b. The method 1000 then includes independently moving 1015 the first arm 110a to adjust a position of the first antler 120a. In one embodiment, one or more first position fixing mechanism 615a are adjusted to fix a position of the first arm 110a. Next, the method 1000 includes independently moving 1020 the second arm 110b to adjust a position of the second antler 120b. In one embodiment, one or more second position fixing mechanisms 615b are adjusted to fix a position of the second arm 110b. Then, the method 1000 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a base plate;
a first arm and a second arm movably coupled to the base plate, the first arm and the second arm each movable around at least two axes, the first arm spaced apart from the second arm;
a first holding member coupled to a distal end of the first arm; and
a second holding member coupled to a distal end of the second arm.

2. The apparatus of claim 1, wherein the first arm and the second arm are each movable around three axes.

3. The apparatus of claim 1, wherein the first arm and the second arm are each independently movable.

4. The apparatus of claim 1, further comprising:
a first coupling mechanism movably coupling the first arm to the base plate; and
a second coupling mechanism movably coupling the second arm to the base plate.

5. The apparatus of claim 4, wherein the first coupling mechanism and the second coupling mechanism each comprise a first coupling movable retained by a second coupling, wherein the first coupling of the first arm and the first coupling of the second arm are coupled to the first arm and the second arm respectively, and wherein the second coupling of the first arm and the second coupling of the second arm are each coupled to the base plate.

6. The apparatus of claim 4, wherein the first coupling of the first arm is located on an end of the first arm opposite the distal end of the first arm and the first coupling of the second arm is located on an end of the second arm opposite the distal end of the second arm.

7. The apparatus of claim 4, wherein the first coupling comprises a ball and the second coupling comprises a socket that movably retains the ball.

8. The apparatus of claim 4, wherein each of the first coupling mechanism and the second coupling mechanism comprises a position fixing mechanism that fixes a position of the first arm and the second arm respectively.

9. The apparatus of claim 1, wherein the first arm is coupled to a first side of the base plate and the second arm is coupled to a second side of the base plate opposite the first side.

10. The apparatus of claim 9, wherein the first arm and the first side of the base plate mirrors the second arm and the second side of the base plate.

11. The apparatus of claim 1, wherein the first holding member and the second holding member each comprise one of an adjustable prong clamp and an adjustable utility clamp.

12. The apparatus of claim 1, wherein the base plate further comprises at least one slot and wherein the first arm and the second arm are slidably movable to adjust a distance between the first arm and the second arm.

13. The apparatus of claim 1, wherein the first arm and the second arm are each independently adjustable to adjust a length of the first arm and a length of the second arm respectively.

14. An antler display comprising:
a base plate;
a first arm and a second arm movably coupled to the base plate, the first arm and the second arm each independently movable around three axes, the first arm spaced apart from the second arm;
a first holding member coupled to a distal end of the first arm;
a second holding member coupled to a distal end of the second arm;
a first coupling mechanism movably coupling the first arm to the base plate; and
a second coupling mechanism movably coupling the second arm to the base plate.

15. The antler display of claim 14, wherein the first coupling mechanism and the second coupling mechanism each comprise a first coupling movable retained by a second coupling, wherein the first coupling of the first arm and the first coupling of the second arm are coupled to the first arm and the second arm respectively, and wherein the second coupling of the first arm and the second coupling of the second arm are each coupled to the base plate.

16. The antler display of claim 14, wherein the first coupling of the first arm is located on an end of the first arm opposite the distal end of the first arm and the first coupling of the second arm is located on an end of the second arm opposite the distal end of the second arm.

17. The antler display of claim 14, wherein the first arm is coupled to a first side of the base plate and the second arm is coupled to a second side of the base plate opposite the first side.

18. The antler display of claim 17, wherein the first arm and the first side of the base plate mirrors the second arm and the second side of the base plate.

19. A method comprising:
securing a first antler in a first holding member coupled to a distal end of a first arm, the first arm movably coupled to a base plate;
securing a second antler in a second holding member coupled to a distal end of a second arm, the second arm movably coupled to the base plate, the first arm and the second arm each movable around at least two axes, the first arm spaced apart from the second arm;
independently moving the first arm to adjust a position of the first antler; and
independently moving the second arm to adjust a position of the second antler.

20. The method of claim 19, wherein a first coupling mechanism movably couples the first arm to the base plate and a second coupling mechanism movably couples the second arm to the base plate, the first coupling mechanism comprising a first position fixing mechanism and the second coupling mechanism comprising a second position fixing mechanism, the method further comprising:
adjusting the first position fixing mechanism to fix a position of the first arm; and
adjusting the second position fixing mechanism to fix a position of the second arm.
